(19) United States
(12) Patent Application Publication
(10) Pub. No.: US 2020/0022056 A1
(43) Pub. Date: Jan. 16, 2020

(54) PATH CONTROLLER AND PATH CONTROL METHOD

(71) Applicant: FUJITSU LIMITED, Kawasaki-shi (JP)

(72) Inventors: Koichiro Yamashita, Hachioji (JP); Takahisa Suzuki, Yokohama (JP)

(73) Assignee: FUJITSU LIMITED, Kawasaki-shi (JP)

(21) Appl. No.: 16/443,570

(22) Filed: Jun. 17, 2019

(30) Foreign Application Priority Data
Jul. 12, 2018 (JP) 2018-132407

(51) Int. Cl. H04W 40/18; H04W 40/20; H04W 40/12; H04W 40/04

(52) U.S. Cl. CPC H04W 40/18; H04W 40/04; H04W 40/12; H04W 40/20

(57) ABSTRACT

A path controller includes a memory, and a processor coupled to the memory and configured to acquire a weather condition of an installation place of a plurality of nodes, the weather condition changing a communication quality of the plurality of nodes, and control a node that is a connection candidate in the plurality of nodes, based on the acquired weather condition so as to determine a communication path between the plurality of nodes.

### CROSS-REFERENCE TO RELATED APPLICATION

This application is based upon and claims the benefit of priority of the prior Japanese Patent Application No. 2018-132407, filed on Jul. 12, 2018, the entire contents of which are incorporated herein by reference.

### FIELD

The embodiments discussed herein are related to a path controller and a path control method.

### BACKGROUND

There are wireless networks built outdoors for environmental monitoring and infrastructure monitoring such as roads.

In such a wireless network, even when a communication device is installed at a fixed position, a wireless connection state between the communication devices may be changed due to a meteorological change, a vegetation change, and disturbance of a flying object or the like.

Related techniques are disclosed in, for example, International Publication Pamphlet No. WO 2010/016477 and Japanese Laid-open Patent Publication No. 2003-069620.

### SUMMARY

According to an aspect of the invention, a path controller includes a memory, and a processor coupled to the memory and configured to acquire a weather condition of an installation place of a plurality of nodes, the weather condition changing a communication quality of the plurality of nodes, and control a node that is a connection candidate in the plurality of nodes, based on the acquired weather condition so as to determine a communication path between the plurality of nodes.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an outline of a configuration of a communication system according to an embodiment;

FIGS. 2A and 2B are block diagrams schematically illustrating a system configuration of the communication system illustrated in FIG. 1;

FIG. 3 is a block diagram schematically illustrating a hardware configuration of a server illustrated in FIGS. 2A and 2B;

FIGS. 4A to 4C are diagrams illustrating an example of a change in a connection state in the communication system illustrated in FIGS. 2A and 2B;

FIG. 5 is a diagram illustrating a positional relationship of respective nodes in the communication system illustrated in FIGS. 4A to 4C;

FIGS. 6A to 6C are diagrams illustrating details of an example of a change in a connection state in the communication system illustrated in FIGS. 4A to 4C;

FIGS. 7A and 7B are graphs illustrating a relationship between a communication quality and arrival data in the communication system illustrated in FIGS. 4A to 4C;

FIGS. 8A and 8B are graphs illustrating a relationship among a communication quality, an amount of precipitation, and a temperature in the communication system illustrated in FIGS. 4A to 4C;

FIGS. 9A and 9B are graphs illustrating a relationship among a communication quality, a soil moisture content, and an amount of precipitation in the communication system illustrated in FIGS. 4A to 4C;

FIGS. 10A and 10B are diagrams illustrating a regrouping processing in the communication system illustrated in FIGS. 4A to 4C;

FIGS. 11A and 11B are flowcharts illustrating a network construction processing when a node in the communication system illustrated in FIGS. 2A and 2B is installed;

FIGS. 12A and 12B are flowcharts illustrating a processing in a quiet operation mode in the communication system illustrated in FIGS. 2A and 2B;

FIGS. 13A and 13B are flowcharts illustrating a processing in a disturbance generation mode in the communication system illustrated in FIGS. 2A and 2B; and

FIGS. 14A and 14B are flowcharts illustrating a processing in a post disturbance mode in the communication system illustrated in FIGS. 2A and 2B.

### DESCRIPTION OF EMBODIMENTS

When wireless devices are installed over a wide range in a wireless network, there is a possibility that a communication quality may be improved by an influence of disturbance and communication may be available between communication devices that are not normally in a communication range. However, when the communication quality returns to a state before the generation of the influence of the disturbance, the communication between the communication devices may be interrupted and the transmission data may be lost which is problematic.

When a connection path is selected while predicting a communication state all the time by utilizing environment information or history, a calculation is always performed to select the connection path, which may cause a processing load in the communication device. Further, by performing a calculation to select the connection path, a chance of transiting a mode of a communication device to a sleep mode in which power saving of the communication device is performed is decreased to increase the power consumption, which may increase the operation cost.

Hereinafter, with reference to the accompanying drawing, descriptions will be made on an embodiment of a technology in which a connection in a wireless network is stabilized. However, the embodiment described below is merely an example, and is not intended to exclude an application of various modifications or technologies that are not specified in the embodiment. That is, the present embodiment may be variously modified and implemented without departing from the scope of the embodiment.

Each of the drawings is not intended to include only the constituent elements illustrated in the drawing, and may include other functions and the like.

Hereinafter, in the drawing, the same parts are denoted with the same reference numerals, and descriptions thereof will be omitted.

### [A] Embodiment

### [A-1] Configuration Example of System

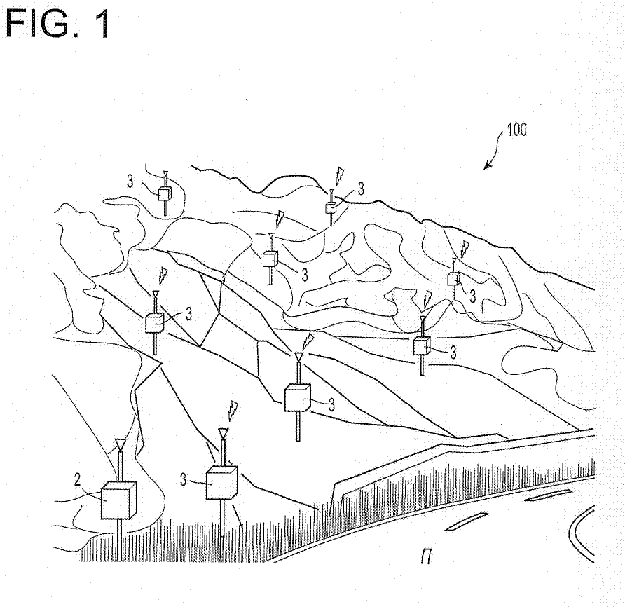

FIG. 1 is a diagram illustrating an outline of a configuration of a communication system 100 according to an embodiment.

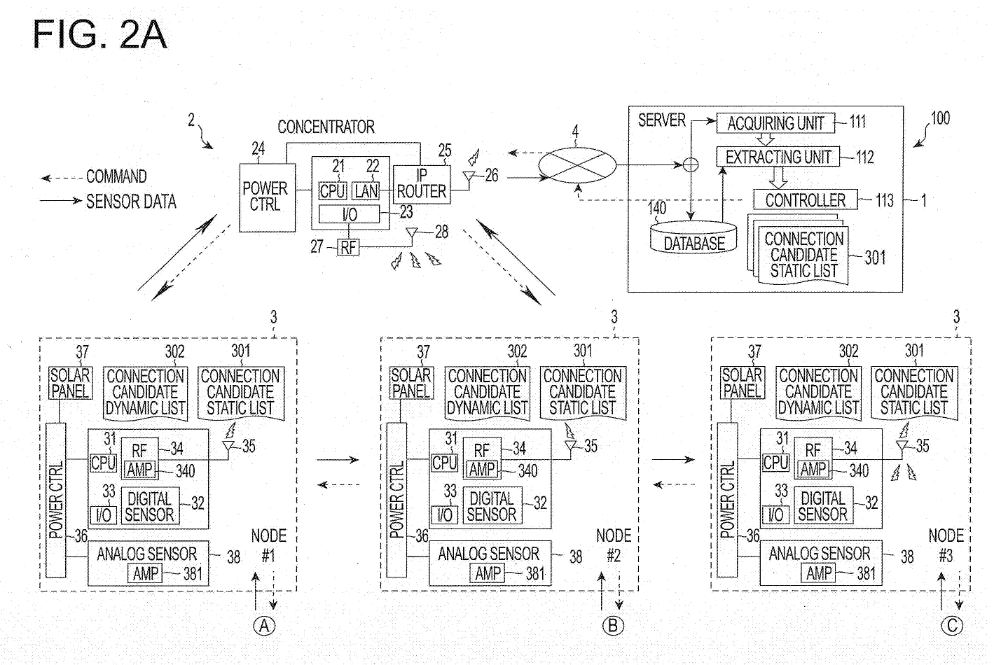

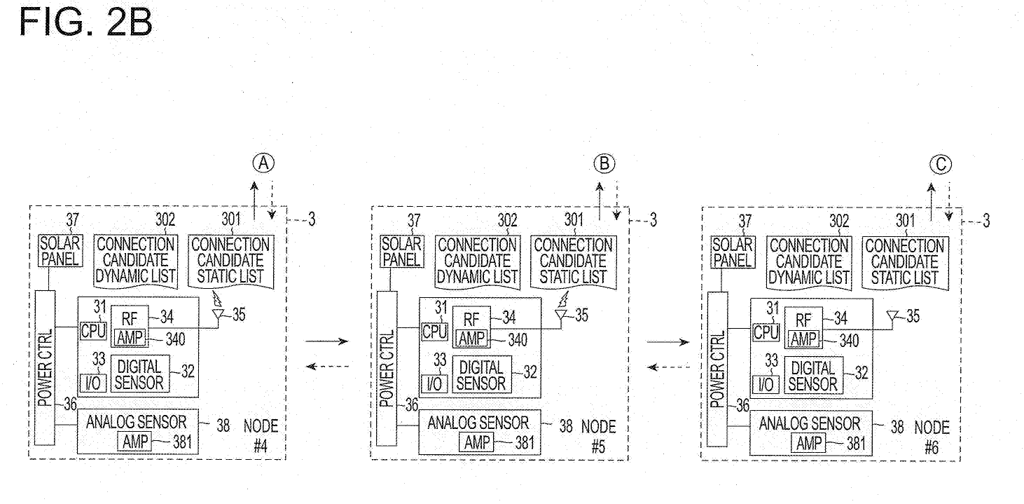

The communication system 100 includes a concentrator 2 (which may also be referred to as a gateway 2) and a plurality (in the illustrated example, 8 (eight)) of nodes 3 (also referred to as sensor nodes 3). Further, the communication system 100 includes a server 1 which is to be described below with reference to FIGS. 2A and 2B in addition to the concentrator 2 and the plurality of nodes 3.

Hereinafter, the concentrator 2 and the nodes 3 may be collectively referred to as a “communication device”.

Each communication device is connected with a communication device installed in a neighboring area to be wirelessly communicable. Further, each communication device is installed in a place in which a meteorological change, a vegetation change, or disturbance by a flying object and the like may occur (e.g., outdoors).

FIGS. 2A and 2B are block diagrams schematically illustrating a system configuration of the communication system 100 illustrated in FIG. 1.

The communication system 100 includes the server 1 (also referred to as a “path controller”), the concentrator 2, and the plurality (in the illustrated example, 6 (six)) of nodes 3 (also referred to as nodes #1 to #6).

The concentrator 2 includes a CPU 21, a LAN card 22, an I/O adapter 23, a power Ctrl 24, an IP router 25, an antenna 26, an RF module 27, and an antenna 28. Further, the CPU is an abbreviation of a Central Processing Unit, the LAN is an abbreviation of a Local Area Network, and the I/O is an abbreviation of Input/Output. Further, the Ctrl is an abbreviation of a controller, the IP is an abbreviation of an Internet Protocol, and the RF is an abbreviation of a Radio Frequency.

The CPU 21 is a processing device that performs various controls or calculations, and implements various functions such as transmission and reception of a command or sensor data (also referred to as sensing data).

The LAN card 22 is an interface that enables the concentrator 2 to be communicably connected with the server 1.

The I/O adaptor 23 controls input/output between the concentrator 2 and each node 3.

The power Ctrl 24 controls a power supply to each unit within the concentrator 2.

The IP router 25 relays a wireless communication between the concentrator 2 and the network 4 by using the standard of the TCP/IP (Transmission Control Protocol/Internet Protocol).

The antenna 26 performs a transmission and reception of a wireless signal between the concentrator 2 and the network 4.

The RF module 27 relays a wireless communication between the concentrator 2 and each node 3 according to a wireless standard of each node 3.

The antenna 28 performs a transmission and reception of a wireless signal between the concentrator 2 and each node 3.

Each node 3 includes a CPU 31, a digital sensor 32, an I/O adapter 33, an RF module 34, an antenna 35, a power Ctrl 36, a solar panel 38, and an analog sensor 38. Further, each node 3 maintains a connection candidate static list 301 and a connection candidate dynamic list 302 in a storage device (not illustrated).

The CPU 31 is a processing device that performs various controls or calculations, and implements various functions such as a measurement of sensor data and transmission and reception of a command or sensor data.

The digital sensor 32 acquires sensor data such as, for example, a temperature, an amount of precipitation, and a soil moisture content around the node 3 by a digital scheme.

The I/O adaptor 33 controls input/output between an own node 3 and other nodes 3, or between the own node 3 and the concentrator 2.

The RF module 34 relays a wireless communication between the own node 3 and other nodes 3, or between the own node 3 and the concentrator 2 according to a wireless standard of the concentrator 2. In addition, the RF module 34 includes an amplifier (AMP) 340 that amplifies a wireless signal.

The antenna 35 performs a transmission and reception of a wireless signal between the own node 3 and other nodes 3, or between the own node 3 and the concentrator 2.

The power controller 36 controls a supply of power to each unit within the node 3.

The solar panel 37 acquires power to be supplied to each unit within the node 3 by the solar energy.

The analog sensor 38 acquires sensor data such as, for example, a temperature, an amount of precipitation, and a soil moisture content around the node 3 by an analog scheme. In addition, the analog sensor 38 includes an amplifier (AMP) 381 that amplifies the sensed signal.

The connection candidate static list 301 is a static list representing other nodes 3 that are connection candidates of each node 3 based on information about each node 3 grouped by the server 1.

The connection candidate dynamic list 302 is a dynamic list representing other nodes 3 that are connection candidates of each node 3 which is changed according to a communication quality when a communication environment is changed by disturbance.

Each node 3 is directly and wirelessly communicable with other nodes 3 located in a neighboring area. In the example illustrated in FIGS. 2A and 2B, node #1 is directly and wirelessly communicable with other nodes #2 and #4.

Each node 3 located in a neighboring area of the concentrator 2 is directly and wirelessly communicable with the concentrator 2. In the example illustrated in FIGS. 2A and 2B, for example, nodes #1 and #2 are directly and wirelessly communicable with the concentrator 2.

Each node 3 that is not located in a neighboring area of the concentrator 2 is directly and wirelessly communicable with the concentrator 2 through one or the plurality of other nodes 3. In the example illustrated in FIGS. 2A and 2B, for example, node #3 may be wirelessly communicable with the concentrator 2 through node #2. Further, for example, node #6 may be wirelessly communicable with the concentrator 2 through nodes #2 and #5.

In FIGS. 2A and 2B, the dashed arrow represents a transmission and reception of a command signal, and the thick solid arrow represents a transmission and reception of a sensor data signal. The concentrator 2 receives a command signal from the server 1 and transmits a sensor data signal to the server 1 through the network 4. Further, the concentrator 2 transmits a command signal to the node 3 located in the neighboring area (in the illustrated example, nodes #1 and #2), and receives a sensor data signal from the node 3 located in the neighboring area (in the illustrated example, nodes #1 and #2). Further, each node 3 performs the transmission and reception of a command signal or a sensor data signal with other nodes 3 located in the neighboring area.

The server 1 controls a connection path between the nodes 3, and functions as an acquiring unit 111, an extracting unit 112, and a controller 113. Further, the server 1 maintains the connection candidate static list 301 and sensor data in the database 140.

The acquiring unit 111 acquires a weather condition in an installation place of the plurality of nodes 3. That is, the acquiring unit 111 detects a sign of an occurrence of generation of abnormality, such as disturbance with respect to each node 3, based on the sensor data acquired from each node 3 through the concentrator 2.

The extracting unit 112 extracts the sensor data acquired by the acquiring unit 111 from the database 140.

The controller 113 determines whether a connection path is limited between the nodes 3 based on the sensor data extracted by the extracting unit 112, and transmits the result of the determination to each node 3 through the network 4 and the concentrator 2. That is, the controller 113 controls the node 3 of the connection candidate in each of the plurality of nodes 3 based on the weather condition acquired by the acquiring unit 111.

When a weather condition is a first state in which disturbance for the plurality of nodes 3 is not generated, the controller 113 operates each node 3 in a quiet operation mode. Further, the controller 113 controls a node 3 of a connection candidate for each node 3 by a path that is determined to be connectable by a measurement of the communication quality in each node 3 and is permitted to be connected in the first state.

Here, the path permitted to be connected in the first state is defined by the connection candidate static list 301.

When a minimum value of a communication quality among the communication qualities measured several times for a specific path among the plurality of nodes 3 is equal to or larger than a threshold value in the first state, the controller 113 determines that the corresponding path is a path permitted to be connected in the first state.

When the weather condition is a second state in which disturbance for the plurality of nodes 3 is generated, the controller 113 operates each node 3 in a disturbance generation mode. Further, the controller 113 controls the node 3 of the connection candidate for each node 3 by the path determined to be connectable by the measurement of the communication quality in each node 3.

When the weather condition is a third state that is within a predetermined period of time after the generation of the disturbance for the plurality of nodes 3, the controller 113 operates each node 3 in a post disturbance mode. Further, the controller 113 controls the node 3 of the connection candidate for each node 3 by the path that is determined to be connectable by the measurement of the communication quality in each node 3 and is permitted to be connected in the third state.

Here, the path permitted to be connected in the third state is defined by the connection candidate static list 301.

When a minimum value of a communication quality among the communication qualities measured several times for a specific path among the plurality of nodes 3 is equal to or larger than a threshold value in the third state, the controller 113 determines that the corresponding path is a path permitted to be connected in the third state.

The function as the server 1 may be incorporated into the concentrator 2.

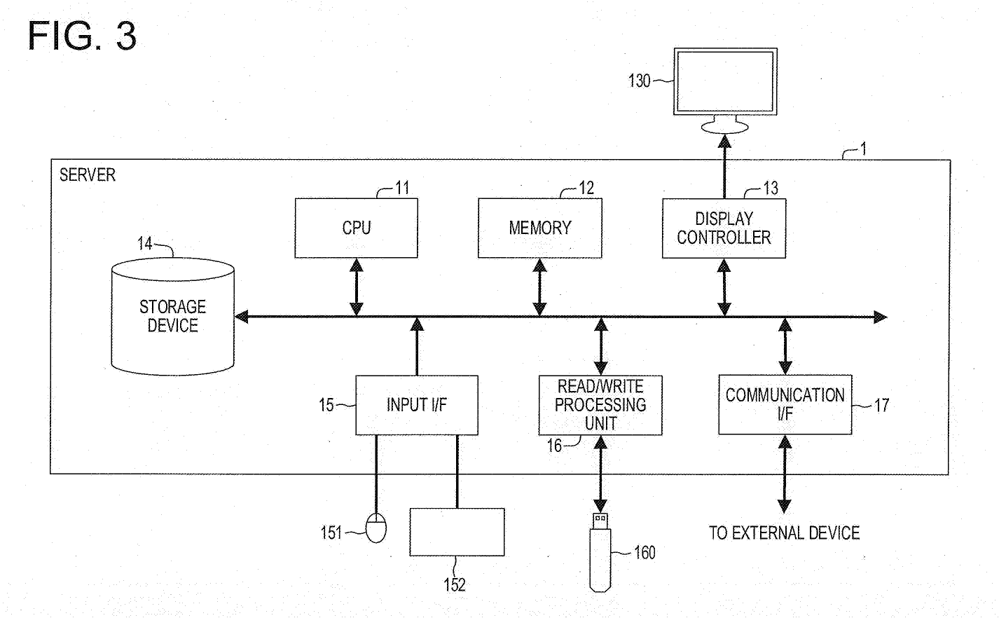

FIG. 3 is a block diagram schematically illustrating a hardware configuration of the server 1 according to the embodiment.

The server 1 includes a CPU 11, a memory 12, a display controller 13, a storage device 14, an input interface (I/F) 15, a read/write processing unit 16, and a communication I/F 17.

The memory 12 is a storage device that includes, for example, a Read Only Memory (ROM) and a Random Access Memory (RAM). A program such as, for example, a Basic Input/Output System (BIOS) may be recorded in the ROM of the memory 12. The software program of the memory 12 may be appropriately read and executed by the CPU 11. In addition, the RAM of the memory 12 may be used as a primary recording memory or a working memory.

The display controller 13 is connected with the display device 130 to control the display device 130. The display device 130 is, for example, a liquid crystal display, an Organic Light-Emitting Diode (OLED) display, a Cathode Ray Tube (CRT), an electronic paper display, and the like, and displays various information on an operator and the like. The display device 130 may be a combination with an input device, and may be, for example, a touch panel.

The storage device 14 is, for example, a device that stores data in a readable and writable manner, and for example, a Hard Disk Drive (HDD), a Solid State Drive (SSD), and a Storage Class Memory (SCM) may be used. The storage device 14 stores the database 140 illustrated in FIGS. 2A and 2B.

The input I/F 15 is connected with an input device such as a mouse 151 or a keyboard 152 to control the input device, such as the mouse 151 or the keyboard 152. The mouse 151 or the keyboard 152 is an example of the input device, and an operator performs various input manipulation through the input devices.

The read/write processing unit 16 is configured such that a recording medium 160 is mountable thereon. The read/write processing unit 16 is configured to be able to read information recorded in the recording medium 160 in a state where the recording medium 160 is mounted. In the present example, the recording medium 160 has portability. The recording medium 160 is, for example, a flexible disk, an optical disk, a magnetic disk, a magneto-optical disk, a semiconductor memory, or the like.

The communication I/F 17 is an interface that enables communication with an external device. The communication I/F 17 is communicably connected with the concentrator 2 through the network 4 as illustrated in FIGS. 2A and 2B.

The CPU 11 is a processing device that performs various controls and calculations, and implements various functions by executing an Operating System (OS) or a program stored in the memory 12. That is, the CPU 11 of the server 1 functions as the acquiring unit 111, the extracting unit 112, and the controller 113 as illustrated in FIGS. 2A and 2B.

A program that implements the functions of the acquiring unit 111, the extracting unit 112, and the controller 113 is provided, for example, in the form of being recorded in the recording medium 160 described above. Further, a computer reads the program from the recording medium 160 through the read/write processing unit 16, transmits the program to an internal storage device or an external storage device, and stores the program in the internal storage device or the external storage device for use. Further, the program may be recorded in a storage device (recording medium) such as, for example, a magnetic disk, an optical disk, and a magneto-optical disk, and may be provided to the computer through a communication path from the storage device.

When the functions of the acquiring unit 111, the extracting unit 112, and the controller 113 are implemented, the program stored in the internal storage device is executed by a microprocessor of the computer. At this time, the computer may read and execute the program recorded in the recording medium 160. Further, in the present embodiment, the internal storage device is the memory 12 and the microprocessor is the CPU 11.

The CPU 11 controls, for example, the entire operation of the server 1. A device that controls the entire operation of the server 1 is not limited to the CPU 11, and may be any one of an MPU, a DSP, an ASIC, a PLD, and an FPGA. Further, a device that controls the entire operation of the server 1 may be a combination of two or more of the CPU, the MPU, the DSP, the ASIC, the PLD, and the FPGA. Further, the MPU is an abbreviation of a Micro Processing Unit, the DSP is an abbreviation of a Digital Signal Processor, and the ASIC is an abbreviation of an Application Specific Integrated Circuit. Further, the PLD is an abbreviation of a Programmable Logic Device, and the FPGA is an abbreviation of a Field Programmable Gate Array.

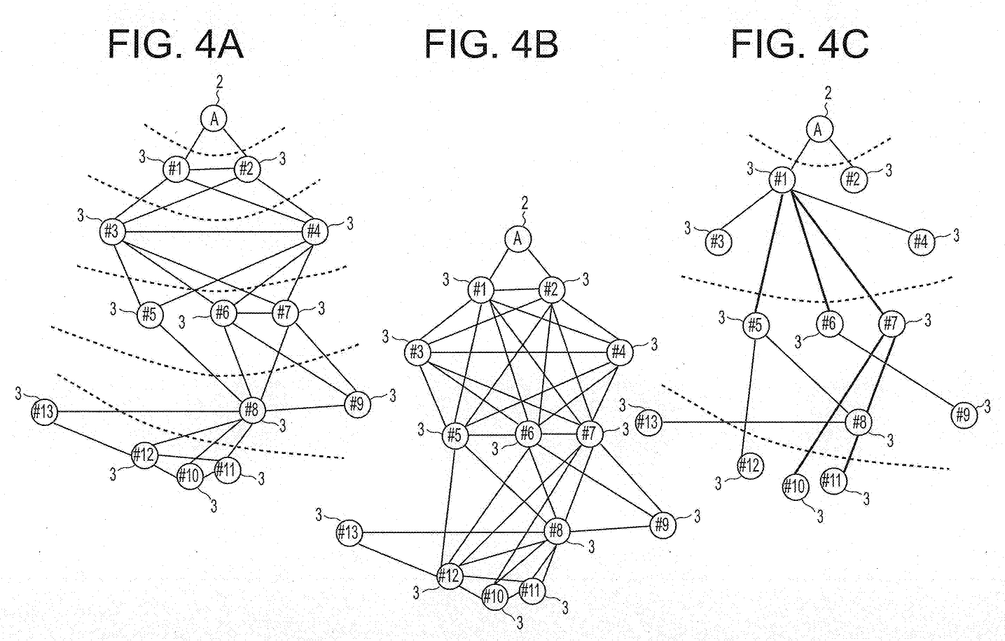

FIGS. 4A to 4C are diagrams illustrating an example of a change in a connection state in the communication system 100 illustrated in FIGS. 2A and 2B. Specifically, FIG. 4A exemplifies a connection state in the quiet operation mode, FIG. 4B exemplifies a connection state in the disturbance generation mode, and FIG. 4C exemplifies a connection state in the post disturbance mode.

In FIG. 4A, the respective nodes 3 are grouped (see, e.g., a dashed line) by a communication quality measured in a quiet state that is neither a rainy environment nor a wet environment, and a path list is not updated according to a daily cycle fluctuation and the like. Further, a connection candidate beyond an adjacent group is not selected, and a non-relay node 3 is set to a sleep state.

In FIG. 4A, as exemplified with the dashed line (group boundary), nodes #1 and #2 belong to the same group, nodes #3 and #4 belong to the same group, nodes #5 to #7 belong to the same group, nodes #8 and #9 belong to the same group, and nodes #10 to #13 belong to the same group.

In the example illustrated in FIG. 4A, for example, node #1 is directly connected with node #2 belonging to the same group as that of node #1, the concentrator 2 existing at an adjacent location, and nodes #3 and #4 existing in the adjacent group.

In FIG. 4B, when disturbance such as rain occurs, the path list represented in FIG. 4A is destroyed, and all of the connection candidates are set to be selectable. Further, a connection path is formed again at every collection timing of sensor data from each node 3 to the server 1, and all nodes 3 are set in a relayable state.

In the example illustrated in FIG. 4B, for example, node #1 is also directly connected with nodes #5 to #7 which do not belong to the adjacent group, in addition to the concentrator 2 and nodes #2 to #4 which are connectable in FIG. 4A.

In FIG. 4C, in a wet state of one to two weeks after rain, the group configuration is changed, and a node 3 that is not directly connected under a normal condition is also set to the node 3 which is directly connected as the node 3 that belongs to the adjacent group. Further, a node which does not relay data is set in a sleep state.

In FIG. 4C, as exemplified with the dashed line, nodes #1 to #4 belong to the same group, nodes #5 to #9 belong to the same group, and nodes #10 to #13 belong to the same group.

In the example represented in FIG. 4C, for example, node #1 is directly connected with nodes #2 to #4 that belong to the same group as that of node #1, the concentrator 2 that exists at an adjacent location, and nodes #5 to #7 that exist in the adjacent group.

Here, in the state after rain represented in FIG. 4C, when rain is detected or a radio field intensity is decreased, the path list returns to the state of rain represented in FIG. 4B. Further, in the state after rain represented in FIG. 4C, when a soil moisture content or humidity is stabilized, the path list returns to the quiet state illustrated in FIG. 4A.

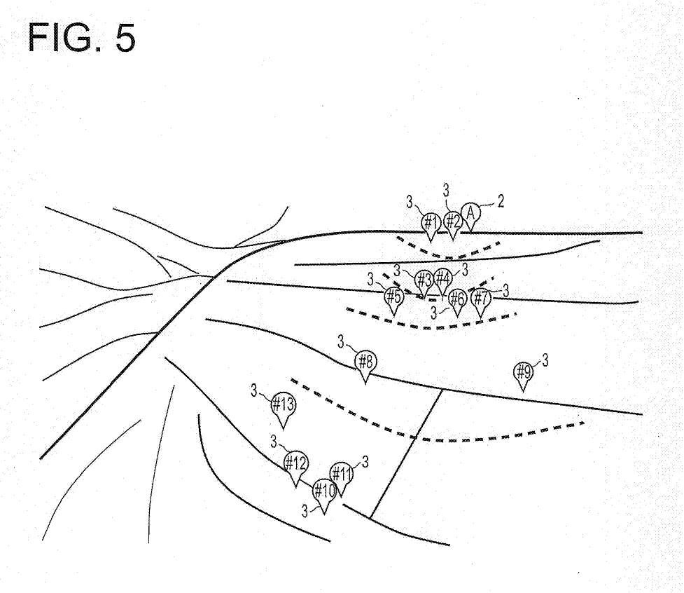

FIG. 5 is a diagram illustrating a positional relationship of respective nodes 3 in the communication system 100 illustrated in FIGS. 4A to 4C.

The concentrator 2 and each node 3 are installed outdoors influenced by disturbance. As represented with the dashed line (group boundary) of FIG. 5, nodes #1 and #2 belong to the same group, nodes #3 and #4 belong to the same group, nodes #5 to #7 belong to the same group, nodes #8 and #9 belong to the same group, and nodes #10 to #13 belong to the same group. Further, the concentrator 2 is located at the vicinity of nodes #1 and #2.

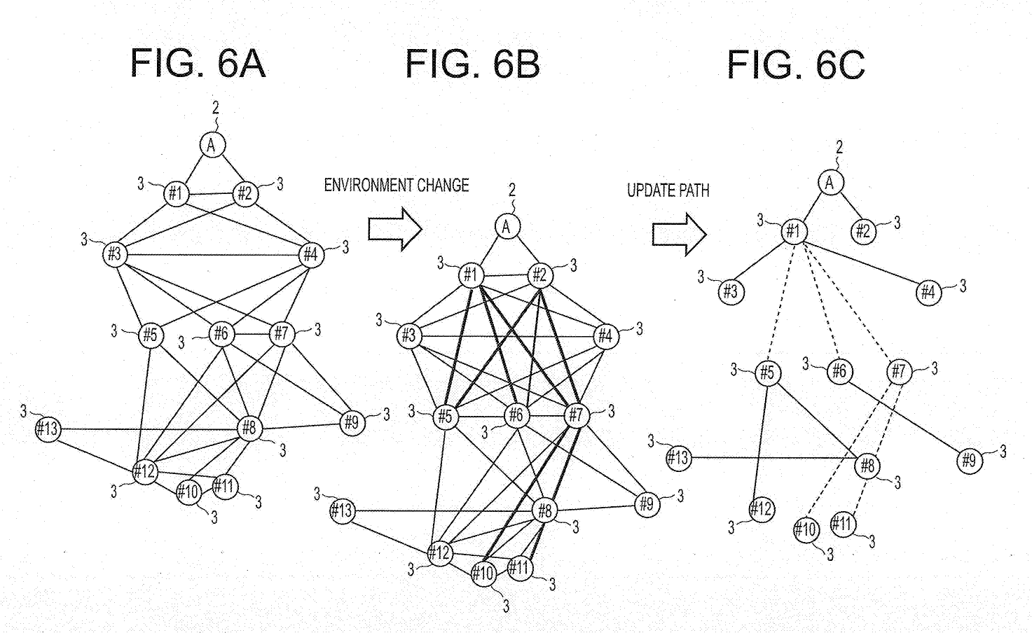

FIGS. 6A to 6C are diagrams illustrating details of an example of a change in a connection state in the communication system 100 illustrated in FIGS. 4A to 4C. Specifically, FIG. 6A exemplifies a connection state in the quiet operation mode, FIG. 6B exemplifies a connection state in the disturbance generation mode, and FIG. 6C exemplifies a connection state in the post disturbance mode.

In FIG. 6A, in a path list in the quiet state, for example, the concentrator 2 is communicable with nodes #1 and #2, node #1 is communicable with nodes #3 and #4, and node #4 is communicable with nodes #5 to #7.

In the state represented in FIG. 6A, when a communication environment is changed by disturbance such as rain or a flying object, the communication quality of a part of the paths is degraded. Further, as illustrated in FIG. 6B, the communication quality of a part of the paths is improved, so that node #1 is communicable with nodes #5 to #7, or node #7 is communicable with nodes #10 and #11 (see, e.g., the thick lines).

In the state represented in FIG. 6B, it is assumed that a path of the shortest route is selected or that it is determined that the communication quality turns to be good, and a new topology is established.

However, when the weather condition returns to the original state from the disturbance generation state, as represented in FIG. 6C, the path from node #1 to nodes #5 to #7 which is not in the connection state in FIG. 6A becomes unstable, and the path from node #7 to nodes #10 to #11 also becomes unstable (see, e.g., the dashed lines). Accordingly, the communication quality in the communication system 100 is degraded, which may cause a communication error such as data loss.

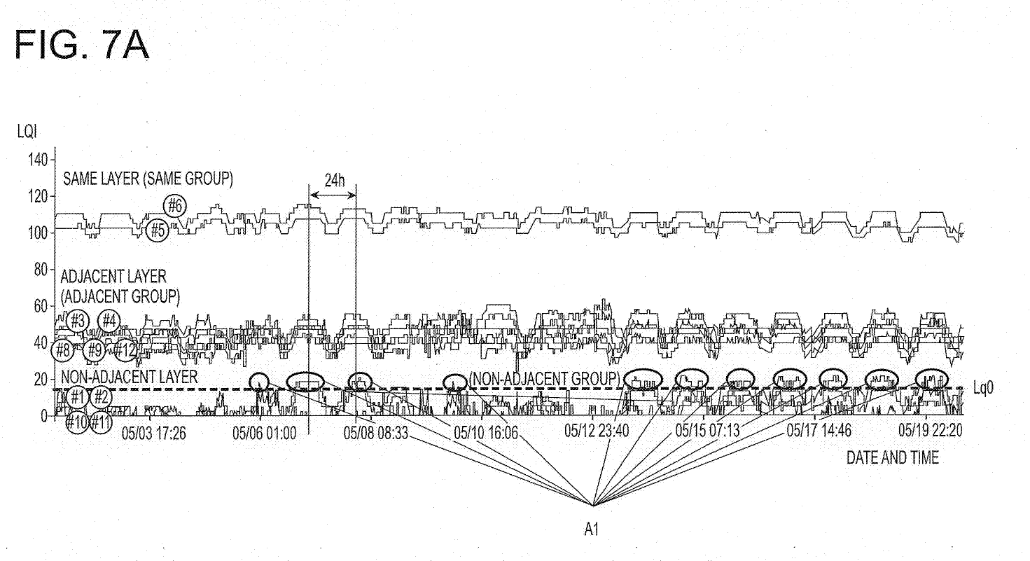

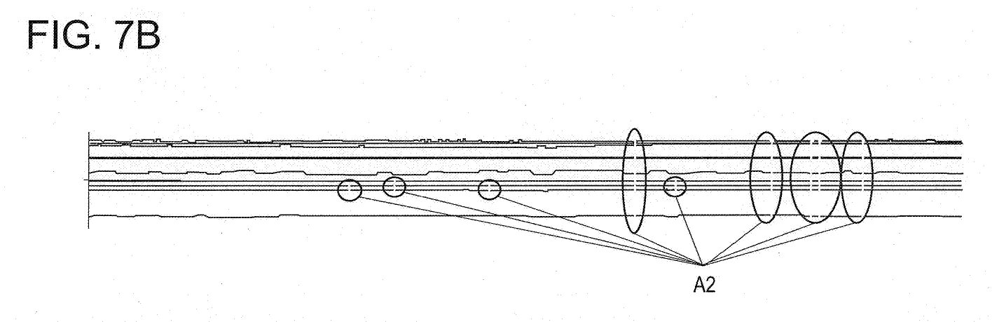

FIG. 7A is a graph illustrating a communication quality in the communication system 100 illustrated in FIGS. 4A to 4C. FIG. 7B is a graph illustrating the quality of arrival data in the communication system 100 illustrated in FIGS. 4A to 4C.

FIG. 7A illustrates a Link Quality Indicator (LQI) of a peripheral node 3 observed from node #7 illustrated in FIGS. 4A to 4C. The LQI repeats rising and falling in a cycle of approximately every 24 hours.

As illustrated in FIGS. 4a to 4c and the like, for node #7, nodes #5 and #6 are located in the vicinity of node #7, nodes #3, #4, #8, #9, and #12 are located in the adjacent groups, and nodes #1, #2, #10, and #11 are located in the non-adjacent groups.

Here, as described with reference to FIG. 6, there is a case where the LQIs of nodes #1, #2, #10, and #11 located in the non-adjacent groups exceed a threshold value Lq0, in which the node is connectable, by the change in the communication quality (see, e.g., reference numeral “A1”). In this case, node #7 is connected with nodes #1, #2, #10, and #11.

When the LQI becomes smaller than the threshold value Lq0 again, as illustrated in FIG. 7B, arrival data of the concentrator 2 is lost (see, e.g., reference numeral “A2”).

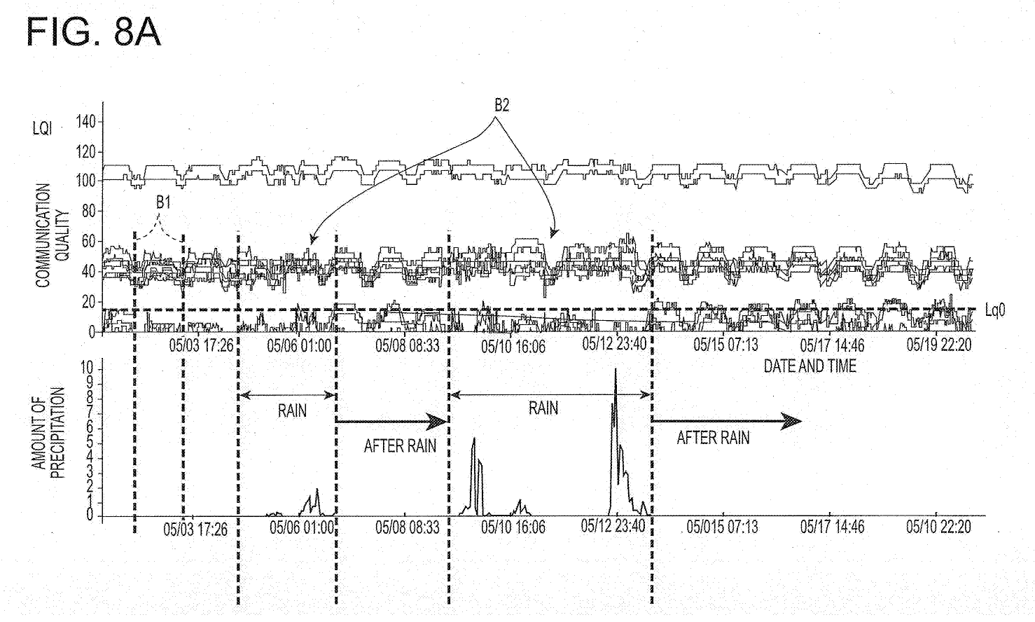

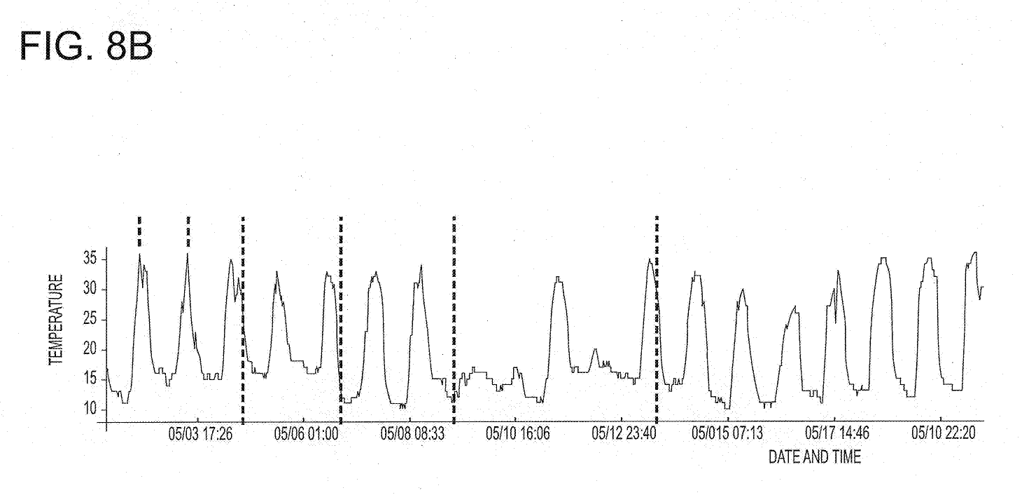

FIGS. 8A and 8B are graphs illustrating a relationship among a communication quality, an amount of precipitation, and a temperature in the communication system 100 illustrated in FIGS. 4A to 4C.

A change in a communication quality by an influence of disturbance is mainly influenced by the weather change and the like.

For example, when a temperature is high, a communication quality tends to be degraded due to an influence of a temperature drift in an analog circuit of the amplifier 340 (see, e.g., FIGS. 2A and 2B) (see reference numeral “B1”).

For example, during rain, a communication quality tends to be considerably unstable due to an influence on a change in dielectric permittivity by moisture in the air (see reference numeral “B2”).

After rain, disturbance of the communication quality is small, but a daily cycle fluctuation range of the communication quality is increased, so that there is a case where the LQI is larger than the threshold value Lq0 after rain.

In the example illustrated in FIGS. 7A and 7B, a node 3 of which a minimum value of LQI in the quiet state is 100 or more (i.e., RSSI≈−50 dBm or more) is defined as the same group, and a node 3 of which a minimum value of LQI in the quiet state is 15 or more and 99 or less (i.e., RSSI≈−80 to −50 dBm) is defined as the adjacent group. Further, when the threshold value Lq0 for a connection permission is 15 (i.e., RSSI≈−80 dBm), a group classification A, {1, 2|3, 4|5, 6, 7|8, 9|10, 11, 12, 13} is established.

In this case, the connection candidate static list 301 that indicates the node 3 connectable from group {1, 2} is defined as {3, 4}, and the connection candidate static list 301 that indicates the node 3 connectable from group {3, 4} is defined as {1, 2} and {5, 6, 7}.

Here, even when the LQI of any one node 3 in group {5, 6, 7} of which the communication quality from group {1, 2} becomes good exceeds the threshold value Lq0, {5, 6, 7}, the group {5, 6, 7} is excluded from the connection candidate by taking a logical product in {3, 4} in the connection candidate static list 301.

After a final connection path is formed, when there is a node 3 which does not involve the relay, the node 3 which does not involve the relay is defined as a non-relay node. Accordingly, since the non-relay node only needs to execute data transmission from the own node 3, there is no need to wait for reception required for relay, thereby suppressing power consumption.

As described above, when rain is detected, the communication quality becomes considerably unstable. At this time, when the connection candidate list is changed by predicting the state each time, a system load is increased. Accordingly, in the example of the present embodiment, when disturbance such as rain is generated, all of the nodes 3 are set to be in a relayable state, and a link configuration is changed based on real-time communication quality information by the connection candidate dynamic list 302 each time.

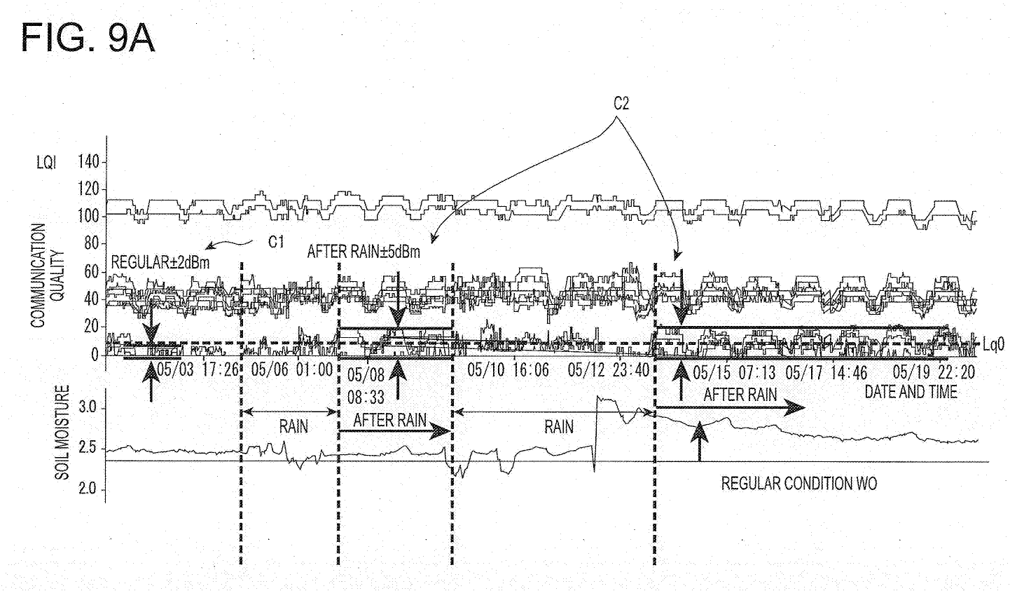

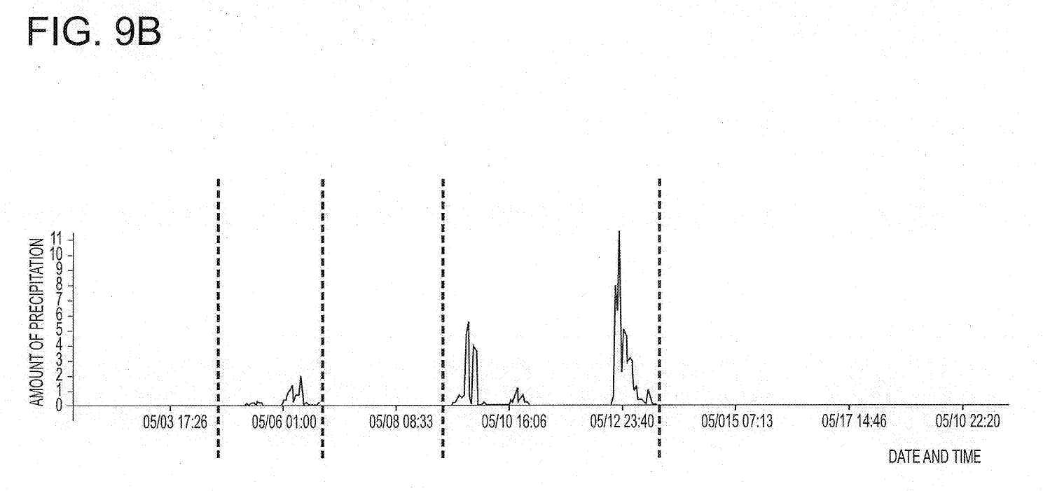

FIGS. 9A and 9B are graphs illustrating a relationship among a communication quality, a soil moisture content, and an amount of precipitation in the communication system 100 illustrated in FIGS. 4A to 4C.

As illustrated in FIGS. 9A and 9B, a daily cycle fluctuation is about ±2 dBm (see reference numeral “C1”) at normal times, but a daily cycle fluctuation may be about ±5 dBm after rain (see reference numeral “C2”). In this case, it may be considered that a connection state is maintained for the node 3 belonging to the non-adjacent group in the period of time after rain.

However, the continuity of the connectable state of the node 3 that belongs to the non-adjacent group is limited to the period of time in which a soil moisture amount is equal to or larger than a predetermined value and a wet state is observed as illustrated in FIGS. 9A and 9B, so that the respective nodes 3 are newly grouped.

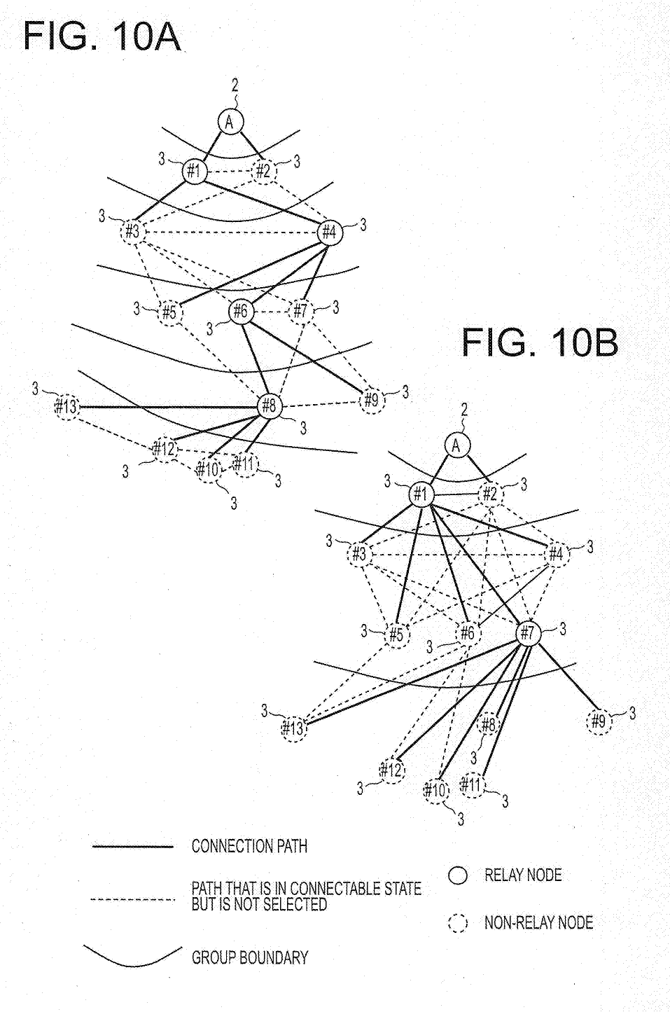

FIGS. 10A and 10B are diagrams illustrating a regrouping processing in the communication system 100 illustrated in FIGS. 4A to 4C. Specifically, FIG. 10A represents a connection path before regrouping in the quiet operation mode, and FIG. 10B represents a connection path after regrouping in the post disturbance mode.

In FIGS. 10A and 10B, a path indicated with the thick solid line represents a connection path, a path indicated with the dashed line represents a path that is connectable, but is not selected, and a curve represents a group boundary. Further, the solid circle represents a relay node, and the dashed circle represents a non-relay node.

In the quiet operation mode represented in FIG. 10A, a group classification A, {1, 2|3, 4|5, 6, 7|8, 9|10, 11, 12, 13} is set. Further, nodes #1, #4, #6, and #8 are set to as the relay nodes 3.

In the post disturbance mode represented in FIG. 10B, a group classification A, {1, 2|3, 4, 5, 6, 7|8, 9, 10, 11, 12, 13} is set by regrouping. Further, nodes #1 and #7 are set as the relay nodes 3.

As described above, the number of hops from the node installed far from the concentrator 2 to the concentrator 2 is decreased by performing the regrouping. Further, the number of non-relay nodes is increased, thereby reducing power consumption in the communication system 100.

### [A-2] Operation Example

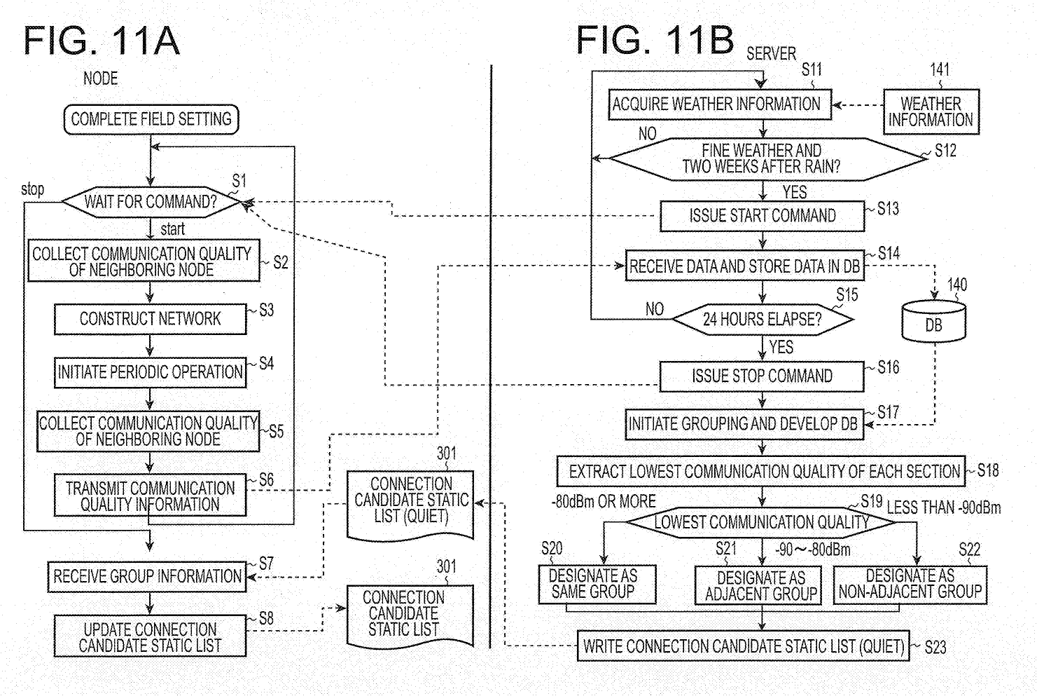

A processing of constructing the network when the node 3 is installed in the communication system 100 illustrated in FIGS. 2A and 2B will be described with reference to a flowchart illustrated in FIGS. 11A and 11B (operations S1 to S8 and S11 to S23). FIG. 11A illustrates a network construction processing in each node 3 (operations S1 to S8), and FIG. 11B illustrates a network construction processing in the server 1 (operations S11 to S23).

As illustrated in FIG. 11A, when the node 3 is completely set in the field, the node 3 waits for a command from the server 1 (operation S1).

When the received command is a start command that indicates an initiation of the construction of the network when the node 3 is installed (see the route “start” of operation S1), the node 3 collects the communication qualities of the neighboring nodes 3 (operation S2).

The node 3 constructs a network with the neighboring node 3 (operation S3).

The node 3 initiates a periodic operation (operation S4).

The node 3 collects the communication qualities of the neighboring nodes 3 (operation S5).

The node 3 transmits information about the communication quality of the neighboring node 3 to the server 1 (operation S6). Then, the processing returns to operation S1.

In operation S1, when the received command is a stop command that indicates a stop of the construction of the network when the node 3 is installed (see, e.g., the route “stop” of operation S1), the processing returns to operation S7. That is, the node 3 receives the connection candidate static list 301 in the quiet state from the server 1 as information about a group configured by each node 3 (also referred to as group information).

The node 3 updates the connection candidate static list 301 maintained for the own node 3 based on the received group information (operation S8). Then, the processing of the construction of the network in each node 3 is completed.

As illustrated in FIG. 11B, the acquiring unit 111 (see, e.g., FIGS. 2A and 2B) of the server 1 acquires weather information 141 in an installation place of each node 3 (operation S11).

The acquiring unit 111 determines whether the weather information 141 indicates a fine weather and within two weeks after rain (operation S12).

When it is determined that the weather information 141 does not indicate a fine weather or within two weeks after rain (see route “NO” of operation S12), the processing returns to operation S11.

In the meantime, when it is determined that the weather information 141 indicates a fine weather and within two weeks after rain (see route “YES” of operation S12), the acquiring unit 111 issues a start command that indicates the initiation of the construction of the network when the node 3 is installed to each node 3 (operation S13).

The acquiring unit 111 receives information about the communication quality with the neighboring node 3 (also referred to as “data”) from each node 3, and stores the received information in the database (DB) 140 (operation S14).

The acquiring unit 111 determines whether 24 hours elapse from the issuance of the start command (operation S15).

When it is determined that 24 hours do not elapse (see route “NO” of operation S15), the processing returns to operation S11. Accordingly, it is possible to acquire the communication quality for the same path from each node 3 several times.

In the meantime, when it is determined that 24 hours elapse (see route “YES” of operation S15), the acquiring unit 111 issues the stop command that indicates the stop of the construction of the network when the node 3 is installed to each node 3 (operation S16).

The extracting unit 112 (see, e.g., FIGS. 2A and 2B) expands the DB 140 so as to initiate grouping each node 3 (operation S17).

The extracting unit 112 extracts the lowest communication quality in each section (i.e., each path) from the expanded DB 140 (operation S18).

The controller 113 (see, e.g., FIGS. 2A and 2B) compares the extracted lowest communication quality with a reference value (operation S19).

When the lowest communication quality is equal to or larger than −80 dBm (see route “−80 dBm or more” of operation S19), the controller 113 designates two nodes 3 which form the corresponding section, as the same group (operation S20).

When the lowest communication quality is equal to or larger than −90 dBm and less than −80 dBm (see route “−90 to 80 dBm” of operation S19), the controller 113 designates two nodes 3 which form the corresponding section, as an adjacent group (operation S21).

When the lowest communication quality is less than −90 dBm (see route “less than −90 dBm” of operation S19), the controller 113 designates two nodes 3 which form the corresponding section, as a non-adjacent group (operation S22).

The controller 113 writes the connection candidate static list 301 in the quiet state and transmits the written connection candidate static list 301 to each node 3 (operation S23). Then, the construction processing of the network in the server 1 is completed.

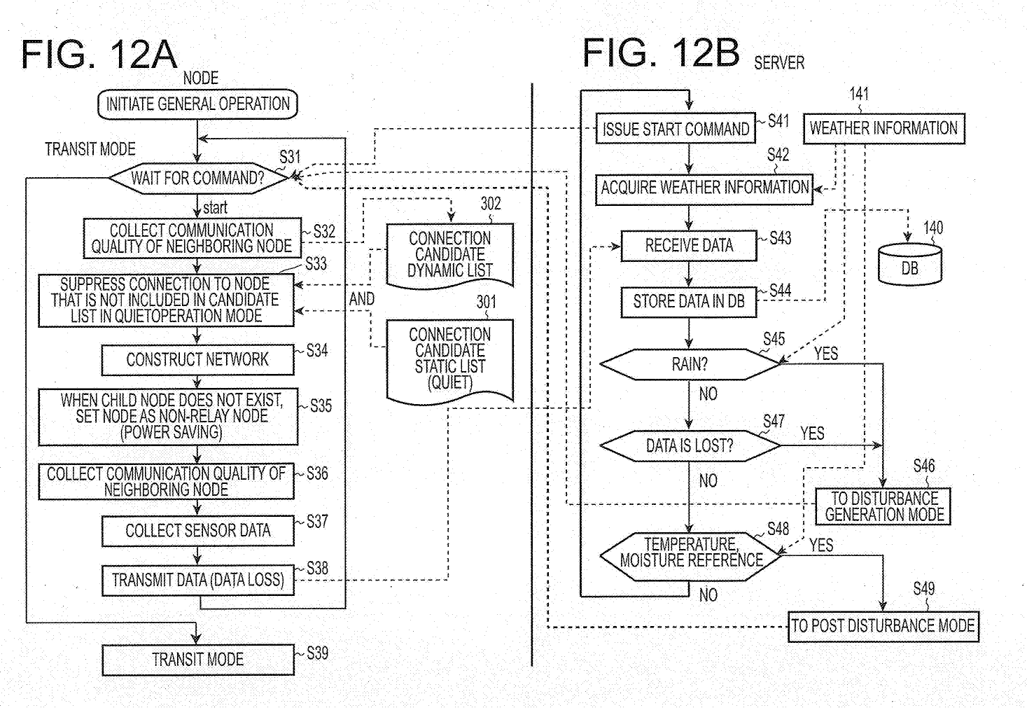

Next, the processing in the quiet operation mode in the communication system 100 illustrated in FIGS. 2A and 2B will be described with reference to a flowchart illustrated in FIGS. 12A and 12B (operations S31 to S39 and S41 to S49). FIG. 12A represents the processing in the quiet operation node in each node 3 (operations S31 to S39), and FIG. 12B represents the processing in the quiet operation node in the server 1 (operations S41 to S49).

As illustrated in FIG. 12A, the node 3 waits for a command from the server 1 (operation S31).

When the received command is a mode transition command that indicates a transition to the disturbance generation mode or the post disturbance mode (see “mode transition” of operation S31), the mode of the node 3 is transited to the disturbance generation mode or the post disturbance mode (operation S39). Then, the processing in the quiet operation mode in each node 3 is terminated.

In the meantime, when the received command is a start command that indicates an initiation of the quiet operation mode (see route “start” of operation S31), the node 3 collects the communication qualities of the neighboring nodes 3 (operation S32). Then, the node 3 registers a list of the currently connectable neighboring nodes 3 in the connection candidate dynamic list 302 based on the collected communication quality.

The node 3 takes a logical product of the current connection candidate dynamic list 302 and the connection candidate static list 301 maintained in the quiet operation mode. Then, the node 3 suppresses the connection of the node 3 that is not included in the connection candidate static list 301 in the quiet operation mode from the current connection candidate dynamic list 302 (operation S33).

The node 3 constructs a network with the neighboring node 3 (operation S34).

When a child node 3 does not exist, the node 3 sets the childe node 3 as a non-relay node (operation S35). That is, a mode of the corresponding node 3 is transited to a power saving mode. Here, the child node 3 is a node 3 connected to a path opposite to a path that heads the concentrator 2 for a specific node 3.

The node 3 collects the communication qualities of the neighboring nodes 3 (operation S36).

The node 3 collects sensor data (operation S37).

The node 3 transmits the collected sensor data and communication qualities to the server 1 (operation S38). In addition, during the transmission of the data, there is a possibility in that data may be lost due to a degradation of the communication quality. Then, the processing returns to operation S31.

As illustrated in FIG. 12B, the acquiring unit 111 (see, e.g., FIGS. 2A and 2B) of the server 1 issues a start command that indicates the initiation of the quiet operation mode to each node 3 (operation S41).

The acquiring unit 111 acquires weather information 141 of an installation place of the node 3 (operation S42).

The acquiring unit 111 receives the sensor data and the communication quality from each node 3 (operation S43).

The acquiring unit 111 stores the received sensor data and communication quality in the DB 140 (operation S44).

The acquiring unit 111 determines whether it does rain based on the weather information 141 (operation S45).

When it is determined that it does rain (see route “YES” of operation S45), the acquiring unit 111 issues the mode transition command to each node 3 so as to transit the mode of each node 3 to the disturbance generation mode (operation S46). Then, the processing in the quiet operation mode in the server 1 is terminated.

In the meantime, when it is determined that it does not rain (see route “NO” of operation S45), the acquiring unit 111 determines whether the sensor data that is received from each node 3 and stored in the DB 140 is lost (operation S47).

When it is determined that the data is lost (see route “YES” of operation S47), the processing proceeds to operation S46.

In the meantime, when it is determined that the data is not lost (see route “NO” of operation S47), the acquiring unit 111 determines whether a temperature, a soil moisture amount, or humidity is larger than a reference value based on the weather information 141 (operation S48).

When it is determined that the temperature, the soil moisture amount, or the humidity is larger than the reference value (see route “YES” of operation S48), the acquiring unit 111 issues the mode transition command to each node 3 so as to transit the mode of each node 3 to the post disturbance mode (operation S49). Then, the processing in the quiet operation mode in the server 1 is terminated.

In the meantime, when it is determined that the temperature, the soil moisture amount, or the humidity is equal to or smaller than the reference value (see route “NO” of operation S48), the processing returns to operation S41.

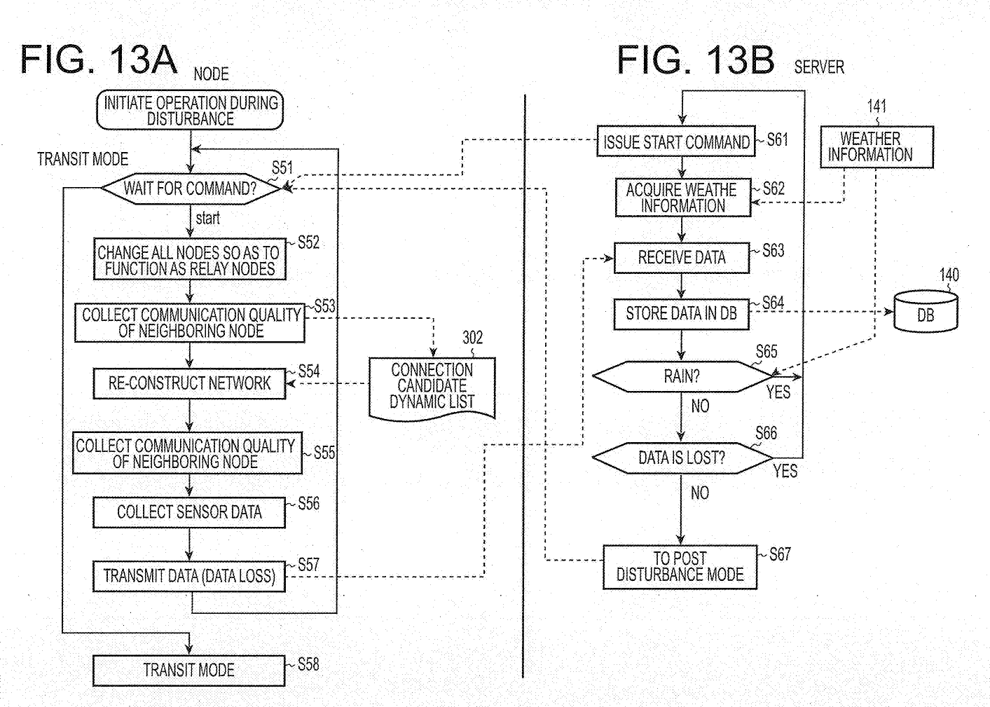

Next, the processing in the disturbance generation mode in the communication system 100 illustrated in FIGS. 2A and 2B will be described with reference to a flowchart illustrated in FIGS. 13A and 13B (operations S51 to S58 and S61 to S67). FIG. 13A represents the processing in the disturbance generation mode in each node 3 (operations S51 to S58), and FIG. 13B represents the processing in the disturbance generation mode in the server 1 (operations S61 to S67).

As illustrated in FIG. 13A, the node 3 waits for a command from the server 1 (operation S51).

When the received command is a mode transition command that indicates the transition to the post disturbance mode (see “mode transition” of operation S51), the mode of the node 3 is transited to the post disturbance mode (operation S58). Then, the processing of the disturbance generation mode in each node 3 is terminated.

In the meantime, when the received command is a start command that indicates an initiation of the disturbance generation mode (see route “start” of operation S51), all nodes 3 change settings so as to function as relay nodes (operation S52).

The node 3 collects the communication qualities of the neighboring nodes 3 (operation S53). Then, the node 3 registers a list of the connectable nodes 3 in the connection candidate dynamic list 302 based on the collected communication quality.

The node 3 re-constructs the network with the neighboring node 3 based on the connection candidate dynamic list 302 (operation S54).

The node 3 collects the communication qualities of the neighboring nodes 3 (operation S55).

The node 3 collects sensor data (operation S56).

The node 3 transmits the collected sensor data to the server 1 (operation S57). Further, during the transmission of the data, there is a possibility that data may be lost due to the degradation of the communication quality. Then, the processing returns to operation S51.

As illustrated in FIG. 13B, the acquiring unit 111 (see, e.g., FIGS. 2A and 2B) of the server 1 issues a start command that indicates the initiation of the disturbance generation mode to each node 3 (operation S61).

The acquiring unit 111 acquires weather information 141 of an installation place of the node 3 (operation S62).

The acquiring unit 111 receives the sensor data from each node 3 (operation S63).

The acquiring unit 111 stores the received sensor data in the DB 140 (operation S64).

The acquiring unit 111 determines whether it does rain based on the weather information 141 (operation S65).

When it is determined that it does rain (see route “YES” of operation S65), the processing returns to operation S61.

In the meantime, when it is determined that it does not rain (see route “NO” of operation S65), the acquiring unit 111 determines whether the sensor data that is received from each node 3 and stored in the DB 140 is lost (operation S66).

When it is determined that the data is lost (see route “YES” of operation S66), the processing proceeds to operation S61.

In the meantime, when it is determined that the data is not lost (see route “NO” of operation S66), the acquiring unit 111 issues the mode transition command to each node 3 so as to transit the mode of each node 3 to the post disturbance mode (operation S67). Then, the processing in the disturbance generation mode in the server 1 is terminated.

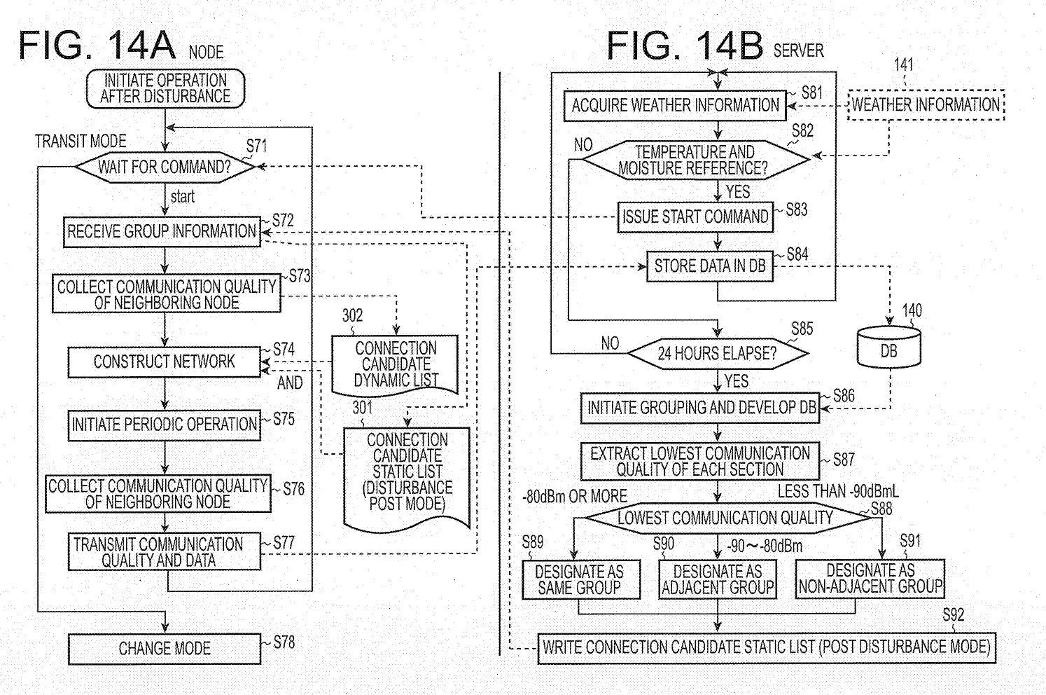

Next, the processing in the post disturbance mode in the communication system 100 illustrated in FIGS. 2A and 2B will be described with reference to a flowchart illustrated in FIGS. 14A and 14B (operations S71 to S78 and S81 to S92). FIG. 14A represents the processing (operations S71 to S78) in the post disturbance mode in each node 3, and FIG. 14B represents the processing (operations S81 to S92) in the post disturbance mode in the server 1.

As illustrated in FIG. 14A, the node 3 waits for a command from the server 1 (operation S71).

When the received command is a mode transition command that indicates a transition to the quiet operation mode or the disturbance generation mode (see “mode transition” of operation S71), the mode of the node 3 is transited to the quiet operation mode or the disturbance generation mode (operation S78). Then, the processing in the post disturbance mode in each node 3 is terminated.

In the meantime, when the received command is a start command that indicates the initiation of the post disturbance mode (see route “start” of operation S71), the node 3 receives the connection candidate static list 301 in the quiet state from the server 1 as group information (operation S72).

The node 3 collects the communication qualities of the neighboring nodes 3 (operation S73). Then, the node 3 registers a list of the currently connectable neighboring nodes 3 in the connection candidate dynamic list 302 based on the collected communication quality.

The node 3 takes a logical product of the current connection candidate dynamic list 302 and the connection candidate static list 301 in the maintained post disturbance mode. Then, the node 3 suppresses the connection to the node 3 which is not included in the connection candidate static list 301 in the post disturbance mode from the current connection candidate dynamic list 302, and constructs a network with the neighboring node 3 (operation S74).

The node 3 initiates a periodic operation (operation S75).

The node 3 collects the communication qualities of the neighboring nodes 3 (operation S76).

The node 3 transmits the collected communication quality and sensor data to the server 1 (operation S77). Then, the processing returns to operation S71.

As illustrated in FIG. 14B, the acquiring unit 111 (see, e.g., FIGS. 2A and 2B) of the server 1 acquires weather information 141 of an installation place of each node 3 (operation S81).

The acquiring unit 111 determines whether a temperature, a soil moisture amount, or humidity is larger than a reference value based on the weather information 141 (operation S82).

When it is determined that the temperature, the soil moisture amount, or the humidity is larger than the reference value (see route “YES” of operation S82), the acquiring unit 111 issues a start command that indicates an initiation of the post disturbance mode to each node 3 (operation S83).

The acquiring unit 111 receives the communication quality and the sensor data received from each node 3 and stores the received communication quality and sensor data in the DB 140 (operation S84). Then, the processing returns to operation S81.

In operation S82, when it is determined that the temperature, the soil moisture amount, or the humidity is equal to or smaller than the reference value (see route “NO” of operation S82), the acquiring unit 111 determines whether 24 hours elapse from the issuance of the start command (operation S85).

When it is determined that 24 hours do not elapse (see route “NO” of operation S85), the processing returns to operation S81. Accordingly, it is possible to acquire the communication quality for the same path from each node 3 several times.

In the meantime, when it is determined that 24 hours elapse (see route “YES” of operation S85), the extracting unit 112 (see, e.g., FIGS. 2A and 2B) develops the DB 140 storing the communication quality of each node 3 so as to initiate grouping the respective nodes 3 (operation S86).

The extracting unit 112 extracts the lowest communication quality in each section between the respective nodes 3 (operation S87).

The controller 113 (see, e.g., FIGS. 2A and 2B) compares the extracted lowest communication quality with a reference value (operation S88).

When the lowest communication quality is equal to or larger than −80 dBm (see route “−80 dBm or more” of operation S88), the controller 113 designates two nodes 3 which form the corresponding section, as the same group (operation S89).

When the lowest communication quality is equal to or larger than −90 dBm and less than −80 dBm (see route “−90 to 80 dBm” of operation S88), the controller 113 designates two nodes 3 which form the corresponding section, as the adjacent group (operation S90).

When the lowest communication quality is less than −90 dBm (see route “less than −90 dBm” of operation S88), the controller 113 designates two nodes 3 which form the corresponding section, as the non-adjacent group (operation S91).

The controller 113 writes the connection candidate static list 301 in the post disturbance mode and transmits the written connection candidate static list 301 to each node 3 (operation S92). Then, the processing of the post disturbance mode in the server 1 is completed.

### [A-3] Effect

In the embodiment described above, according to the communication system 100, for example, the operational effects below may be exhibited.

The acquiring unit 111 acquires the weather condition of an installation place of the plurality of nodes 3. The controller 113 controls the node 3 of the connection candidate in the plurality of nodes 3 based on the weather condition acquired by the acquiring unit 111.

Accordingly, it is possible to stabilize the connection in the wireless network. Specifically, even when a communication quality in a communication path among the plurality of nodes 3 is changed according to the weather situation, it is possible to reduce the number of transmission data loss and decrease the number of hops of the communication path.

When the weather condition is the first state in which the disturbance for the plurality of nodes 3 is not generated, the controller 113 operates each node 3 in the quiet operation mode. Further, the controller 113 controls a node 3 of a connection candidate for each node 3 by a path that is determined to be connectable by a measurement of the communication quality in each node 3 and is permitted to be connected in the first state.

Accordingly, it is possible to stabilize the communication quality in the quiet operation mode in which it does not rain and the environment is not a wet environment.

When the lowest value of the communication quality among the communication qualities measured several times for a specific path among the plurality of nodes 3 is equal to or larger than a threshold value in the first state, the controller 113 determines the corresponding path as the path permitted to be connected in the first state.

Accordingly, the connection only to the path where the communication quality is not degraded in the weather condition in the quiet operation mode, may be permitted.

When the weather condition is the second state in which the disturbance for the plurality of nodes 3 is generated, the controller 113 operates each node 3 in the disturbance generation mode. Further, the controller 113 controls the node 3 of the connection candidate for each node 3 by the path that is determined to be connectable by the measurement of the communication quality in each node 3.

Accordingly, in the disturbance generation mode during rain, it is possible to flexibly change the connection path in accordance with the change in the communication quality due to the disturbance.

When the weather condition is the third state which is within a predetermined period of time after the generation of the disturbance for the plurality of nodes 3, the controller 113 operates each node 3 in the post disturbance mode. Then, the controller 113 controls a node 3 of a connection candidate by a path that is determined to be connectable by a measurement of the communication quality in each node 3 and is permitted to be connected in the third state.

Accordingly, it is possible to stabilize the communication quality in the post disturbance mode of the case of the wet environment after rain.

When the lowest value of the communication quality among the communication qualities measured several times for a specific path among the plurality of modes 3 is equal to or larger than a threshold value in the third state, the controller 113 determines the corresponding path as the path permitted to be connected in the third state.

Accordingly, in the post disturbance mode, the number of hops from the node 3 installed far from the concentrator 2 to the concentrator 2 is decreased. Further, the number of non-relay nodes is increased, thereby reducing the power consumption in the communication system 100.

### [B] Others

The specified technology is not limited to the embodiment, and may be variously modified and implemented without departing from the scope of the present embodiment. Each configuration and each processing of the present embodiment may be selected as necessary or may be combined as appropriate.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A path controller comprising:
a memory; and
a processor coupled to the memory and configured to:
acquire a weather condition of an installation place of a plurality of nodes, the weather condition changing a communication quality of the plurality of nodes; and
control a node that is a connection candidate in the plurality of nodes, based on the acquired weather condition so as to determine a communication path between the plurality of nodes.

2. The path controller according to claim 1,
wherein the processor is configured to, when the weather condition is a first state in which disturbance for the plurality of nodes is not generated, control the node of the connection candidate through a path determined to be communicable by a measurement of a communication quality and permitted to be communicated in the first state.

3. The path controller according to claim 2,
wherein the processor is configured to, when a minimum value of the communication quality measured for a first path of a plurality of paths between the plurality of nodes is equal to or larger than a threshold value in the first state, determine that the first path is a path permitted to be communicated in the first state.

4. The path controller according to claim 1,
wherein the processor is configured to, when the weather condition is a second state in which the disturbance for the plurality of nodes is generated, control the node of the connection candidate through a path determined to be communicable by a measurement of the communication quality.

5. The path controller according to claim 1,
wherein the processor is configured to, when the weather condition is a third state which is within a predetermined period of time after generation of the disturbance for the plurality of nodes, control the node of the connection candidate through a path determined to be communicable by a measurement of the communication quality and permitted to be communicated in the third state.

6. The path controller according to claim 5,
wherein the processor is configured to, when a minimum value of a communication quality measured for a first path of a plurality of paths between the plurality of nodes is equal to or larger than a threshold value in the third state, determine that the first path is a path permitted to be communicated in the third state.

7. A computer-readable non-transitory recording medium storing a program that causes a computer to execute a procedure, the procedure comprising:
acquiring a weather condition of an installation place of a plurality of nodes, the weather condition changing a communication quality of the plurality of nodes; and
controlling a node that is a connection candidate in the plurality of nodes, based on the acquired weather condition so as to determine a communication path between the plurality of nodes.

8. The computer-readable non-transitory recording medium according to claim 7,
wherein when the weather condition is a first state in which disturbance for the plurality of nodes is not generated, the processor controls the node of the connection candidate through a path determined to be communicable by a measurement of a communication quality and permitted to be communicated in the first state.

9. The computer-readable non-transitory recording medium according to claim 8,
wherein when a minimum value of the communication quality measured for a first path of a plurality of paths between the plurality of nodes is equal to or larger than a threshold value in the first state, the procedure determines that the first path is a path permitted to be communicated in the first state.

10. The computer-readable non-transitory recording medium according to claim 7,
wherein when the weather condition is a second state in which the disturbance for the plurality of nodes is generated, the procedure controls the node of the connection candidate through a path determined to be communicable by a measurement of the communication quality.

11. The computer-readable non-transitory recording medium according to claim 7,
wherein when the weather condition is a third state which is within a predetermined period of time after generation of the disturbance for the plurality of nodes, the procedure controls the node of the connection candidate through a path determined to be communicable by a measurement of the communication quality and permitted to be communicated in the third state.

12. The computer-readable non-transitory recording medium according to claim 11,
wherein when a minimum value of a communication quality measured for a first path of a plurality of paths between the plurality of nodes is equal to or larger than a threshold value in the third state, the processor determines that the first path is a path permitted to be communicated in the third state.

13. A path control method comprising:
acquiring a weather condition of an installation place of a plurality of nodes, the weather condition changing a communication quality of the plurality of nodes; and
controlling a node that is a connection candidate in the plurality of nodes, based on the acquired weather condition so as to determine a communication path between the plurality of nodes, by a processor.

14. The path control method according to claim 13,
wherein when the weather condition is a first state in which disturbance for the plurality of nodes is not generated, the processor controls the node of the connection candidate through a path determined to be communicable by a measurement of a communication quality and permitted to be communicated in the first state.

15. The path control method according to claim 14,
wherein when a minimum value of the communication quality measured for a first path of a plurality of paths between the plurality of nodes is equal to or larger than a threshold value in the first state, the processor determines that the first path is a path permitted to be communicated in the first state.

16. The path control method according to claim 13,
wherein when the weather condition is a second state in which the disturbance for the plurality of nodes is generated, the processor controls the node of the connection candidate through a path determined to be communicable by a measurement of the communication quality.

17. The path control method according to claim 13,
wherein when the weather condition is a third state which is within a predetermined period of time after generation of the disturbance for the plurality of nodes, the processor controls the node of the connection candidate through a path determined to be communicable by a measurement of the communication quality and permitted to be communicated in the third state.

18. The path control method according to claim 17,
wherein when a minimum value of a communication quality measured for a first path of a plurality of paths between the plurality of nodes is equal to or larger than a threshold value in the third state, the processor determines that the first path is a path permitted to be communicated in the third state.
